(19) United States
(12) Patent Application Publication
(10) Pub. No.: US 2011/0043530 A1
(43) Pub. Date: Feb. 24, 2011

(54) ELECTRONIC APPARATUS AND METHOD OF CONTROLLING DISPLAY

(75) Inventor: Yasuhiro NOZUKI, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/846,170

(22) Filed: Jul. 29, 2010

(30) Foreign Application Priority Data
Aug. 18, 2009 (JP) 2009-189197

(51) Int. Cl. G06T 1/00

(52) U.S. Cl. 345/522

(57) ABSTRACT

An electric apparatus includes a plurality of function units including a display unit causing a panel display a screen, a central processing unit that executes a first processing of commanding the plurality of function units to start up and executes a second processing of commanding the plurality of function units to operate in accordance with an operation being performed, and a detection unit that detects a state in which a restart operation to be performed during the second processing. The central processing unit executes a third processing for commanding the function units other than the display unit to start up in accordance with a detection result from the detection unit, and the display unit maintains displaying of the screen on the panel until the display unit receives a command to operate from the central processing unit in the second processing after the third processing has been performed.

### CROSS-REFERENCE TO RELATED APPLICATION

This application is based upon and claims the benefit of priority of the prior Japanese Patent Application No. 2009-189197, filed on Aug. 18, 2009, the entire contents of which are incorporated herein by reference.

### FIELD

Various embodiments described herein relate to a technology of controlling display of a screen on a panel of a display unit in an electric apparatus.

### BACKGROUND

A typical system for notifying a user that, for example, a malfunction has occurred in a system by displaying information regarding the malfunction on the screen of a portable terminal device has been discussed (for example, see Japanese Unexamined Patent Application Publication No. 2000-89823). On the other hand, when a malfunction has occurred in a portable telephone or the like, similarly to an exemplary case in which, for example, a malfunction occurs because of increase in the amount of data accumulated in a stack, the malfunction may be easily dealt with by restarting the portable telephone. In such a case, it is more desirable that a restart operation is automatically executed to deal with the malfunction without making the user be aware that a restart operation is being performed than that the user is notified that the malfunction has occurred and is made to perform a restart operation or is made upset or anxious.

Here, start-up processing performed when, for example, the power is turned on generally starts from a state in which nothing is displayed on a screen (black-screen state). Then, in start-up processing, screen display is executed after initialization setting is performed. Thus, if similar start-up processing is performed in restart processing, screen display is suddenly terminated and shifted to being in the black-screen state and a standby screen or the like is displayed on the screen after a time necessary for performing initialization setting has passed. Here, the user may feel upset or anxious because the user does not know that a restart operation is being automatically executed to deal with a malfunction and may simply assume that a malfunction has occurred.

In contrast, a device that, when restart processing is performed, first reads a stored display screen for when a restart operation is performed (hereinafter referred to as a “restart display screen”) and then performs a restart processing to deal with a malfunction has been proposed (for example, see Japanese Unexamined Patent Application Publication No. 2001-14006). As the restart display screen, a pre-stored menu screen or the like is used, or an operation screen displayed when a determination as to whether a restart operation to be performed is made as restart pre-processing is stored in an external memory and this stored operation screen is used. This stored screen is displayed as the restart display screen.

However, when the pre-stored menu screen or the like is displayed as the restart display screen at the time restart processing is performed, an operation screen suddenly changes to the different screen. As a result, the user may assume that a malfunction has occurred and feel upset or anxious. Moreover, in a case in which the operation screen stored in the external memory by the restart pre-processing is displayed as the restart display screen at the time restart processing is performed, if a malfunction occurs, it is assumed that the operation screen may fail to be stored in the external memory because a storage operation is improperly executed. In this case, screen display is improperly performed at the time restart processing is performed. As a result, the user may assume that a malfunction has occurred and feel upset or anxious.

### SUMMARY

According to an aspect of the embodiments discussed herein, an electric apparatus includes a plurality of function units including a display unit, the display unit causing a panel of the display unit to display a screen and maintaining the display of the screen, the function units other than the display unit executing functions other than a function related to the panel, a central processing unit that executes a first processing of commanding the plurality of function units to start up and executes a second processing of commanding the plurality of function units to operate in accordance with an operation being performed, and a detection unit that detects a state in which a restart operation to be performed during the second processing. According to an embodiment, the central processing unit executes a third processing of commanding the function units other than the display unit to start up in accordance with a detection result from the detection unit, and the display unit maintains the display of the screen on the panel until the display unit receives a command to operate from the central processing unit in the second processing after the third processing has been performed.

It is to be understood that both the foregoing general description and the following detailed description are exemplary and explanatory and are not restrictive of the embodiments, as claimed. Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is an external view of a mobile telephone according to a disclosed embodiment;

FIG. 2 is a functional block diagram of the structure of the portable telephone illustrated in FIG. 1;

FIG. 3 is a flowchart of an operation of the portable telephone illustrated in FIG. 2; and

FIGS. 4A, 4B, 4C and 4D illustrate an example of screen display of the portable telephone illustrated in FIG. 2.

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

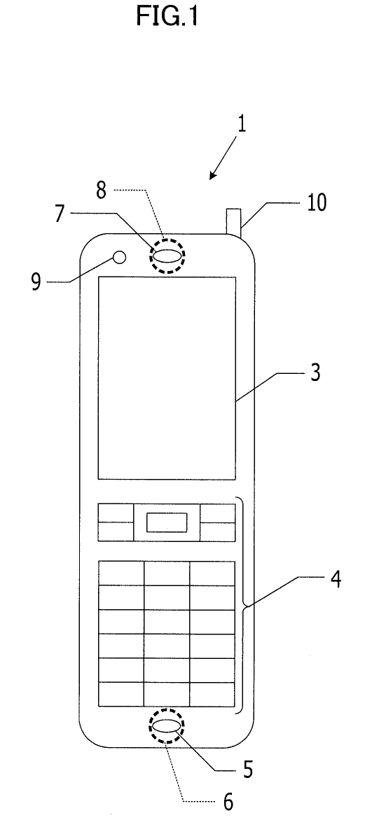

Embodiments of an electric apparatus and a method for controlling display, which are to be disclosed, will be described with reference to FIGS. 1, 2, 3, 4A, 4B, 4C and 4D. A portable telephone 1, which is an embodiment of an electric apparatus disclosed, has a display function using a mounted panel, a calling function and a sending/reception email-message function by performing wireless communication to and from an external center, a photo-capturing function using a mounted camera, and the like. While specific examples of functions of an apparatus are described herein, the present invention is not limited to any particular type or function of an apparatus.

FIG. 1 illustrates an external view of a portable telephone 1. As illustrated in FIG. 1, a panel 3, a keypad 4, a camera 9, an antenna 10, an earpiece 7, and a mouthpiece 5 are arranged on the portable telephone 1. A speaker 8 is arranged behind the earpiece 7, and a microphone 6 is arranged behind the mouthpiece 5.

The panel 3 includes, for example, a liquid crystal panel, and is used to present information, display a cursor for selecting an information item, and the like. The keypad 4 includes a plurality of key switches for inputting operations such as a power key for operating ON/OFF of the power supply, and is used by a user to input operational instructions, data, and the like.

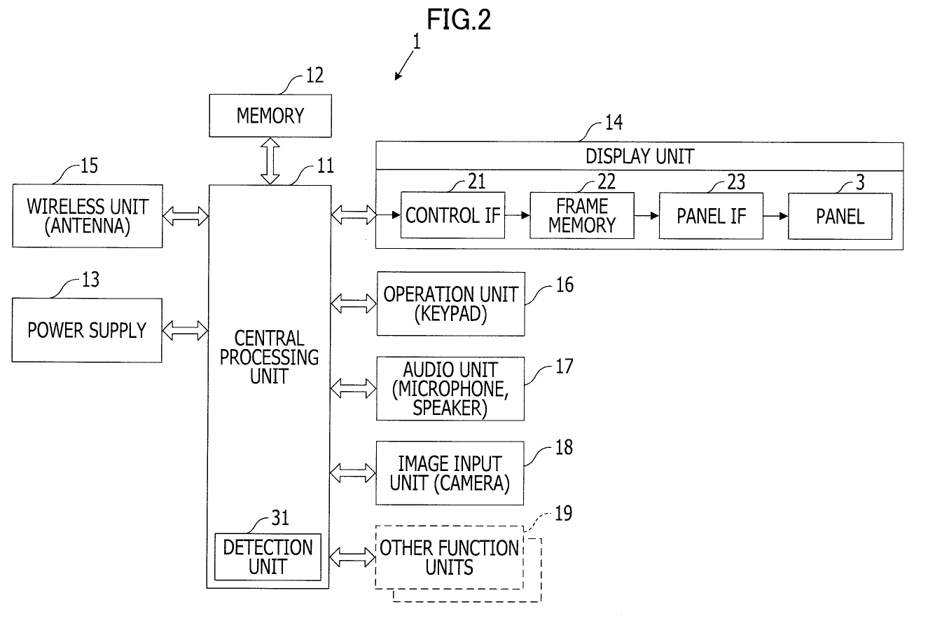

FIG. 2 is a functional block diagram of the portable telephone 1. This portable telephone 1 includes a central processing unit 11, a memory 12, a power supply 13, and a plurality of function units 14, 15, 16, 17, 18 and 19 (14 to 19). The function units 14 to 19 include a display unit 14 for executing functions regarding the panel 3 and function units for executing functions other than the functions regarding the panel 3 (a wireless unit 15, an operation unit 16, an audio unit 17, an image input unit 18, and the other function units 19).

The memory 12 stores data such as received/sent email data, received/made call history data, captured image data, registered data such as telephone numbers and email addresses, and setting data used by various functions of the portable telephone 1 such as the display function. The setting data includes, for example, display parameters used when a screen to be displayed on the panel 3 is created. Moreover, the memory 12 stores a program for realizing various functions of the portable telephone 1. The various functions of the portable telephone 1 are realized when the program stored in the memory 12 is executed by the central processing unit 11.

The central processing unit 11 executes various information processing operations for various functions such as the display function by commanding the display unit 14 and the function units 15, 16, 17, 18 and 19 (15 to 19) to operate, using the data and program stored in the memory 12.

For example, the central processing unit 11 executes writing of data into and reading of data from the memory 12. Moreover, when a key switch of the keypad 4 is pressed, the central processing unit 11 receives an operation input signal via the operation unit 16 and executes a corresponding processing by using the display unit 14 and the function units 15 to 19. Moreover, when a key switch of the keypad 4 is pressed and data is input via the operation unit 16, the central processing unit 11 receives the input data and makes the memory 12 store the input data. Moreover, the central processing unit 11 performs signal processing on a wireless signal input from the wireless unit 15, and executes processing for acquiring audio and data and processing for making the audio and data be sent from the wireless unit 15.

Moreover, as display control processing, the central processing unit 11 creates a screen to be displayed on the panel 3 by using the data stored in the memory 12 and commands the display unit 14 to perform processing for displaying the created screen.

Moreover, the central processing unit 11 executes a first processing such as a start-up processing for commanding the display unit 14 and the function units 15 to 19 to start up (for example, initialization setting and initial operations). Moreover, the central processing unit 11 executes a second processing such as steady-state processing for commanding the display unit 14 and the function units 15 to 19 to operate in accordance with an operation being performed.

Furthermore, the central processing unit 11 includes a detection unit 31 for detecting a state that requires a restart operation during the steady-state processing. In accordance with a detection result from the detection unit 31, the central processing unit 11 executes a third processing such as restart processing in which the function units 15 to 19, not the display unit 14, are commanded to perform initialization setting and initial operations.

The power supply 13 includes a battery and a circuit that controls a power-supply circuit, which generates a power-supply voltage from the battery, and applies the power-supply voltage to various units of circuits of the portable telephone 1. When the power supply 13 is commanded to perform power-ON processing by the central processing unit 11, the power supply 13 applies the power-supply voltage to the various units of the circuits. When the power supply 13 is commanded to perform power-OFF processing by the central processing unit 11, the power supply 13 stops applying the power-supply voltage to all the circuits of the portable telephone 1.

The display unit 14 has both a function of displaying a screen on the panel 3 and a function of maintaining displaying the screen. More specifically, the display unit 14 includes a control interface (IF) 21, which is an interface circuit connected to the central processing unit 11, a frame memory 22, a panel IF 23, which is an interface circuit connecting the frame memory 22 and the panel 3. The frame memory 22 stores a screen input via the control IF 21. The panel 3 maintains screen display by repeatedly displaying a screen, which is stored in the frame memory 22, via the panel IF 23.

The wireless unit 15 includes the antenna 10 and a circuit that transmits and receives wireless signals to and from, respectively, wireless base stations via the antenna 10.

The operation unit 16 includes the keypad 4 and an interface circuit that receives ON/OFF information regarding key switches of the keypad 4 and that inputs key information regarding an operated key switch to the central processing unit 11.

The audio unit 17 includes the microphone 6, the speaker 8, and an interface circuit for the microphone 6 and speaker 8. The audio unit 17 executes, during a telephone conversation, processing for acquiring audio data input via the microphone 6 and outputting the audio data to the central processing unit 11 and processing for outputting data specified by the central processing unit 11 as audio via the speaker 8.

The image input unit 18 sets the shutter setting, the zoom setting, the flash setting, and the like of the camera 9 and controls the camera 9. The image input unit 18 includes an interface circuit for inputting an image pick-up signal from the camera 9, as image data, to the central processing unit 11.

The other function units 19 are function units for executing functions to be installed, which are different from the above-described functions, on the portable telephone 1. Examples of the other function units 19 include a function unit for operating a motor that vibrates the portable telephone 1, a function unit for operating a biometric sensor, and a function unit for operating a circuit that performs infrared communication and the like.

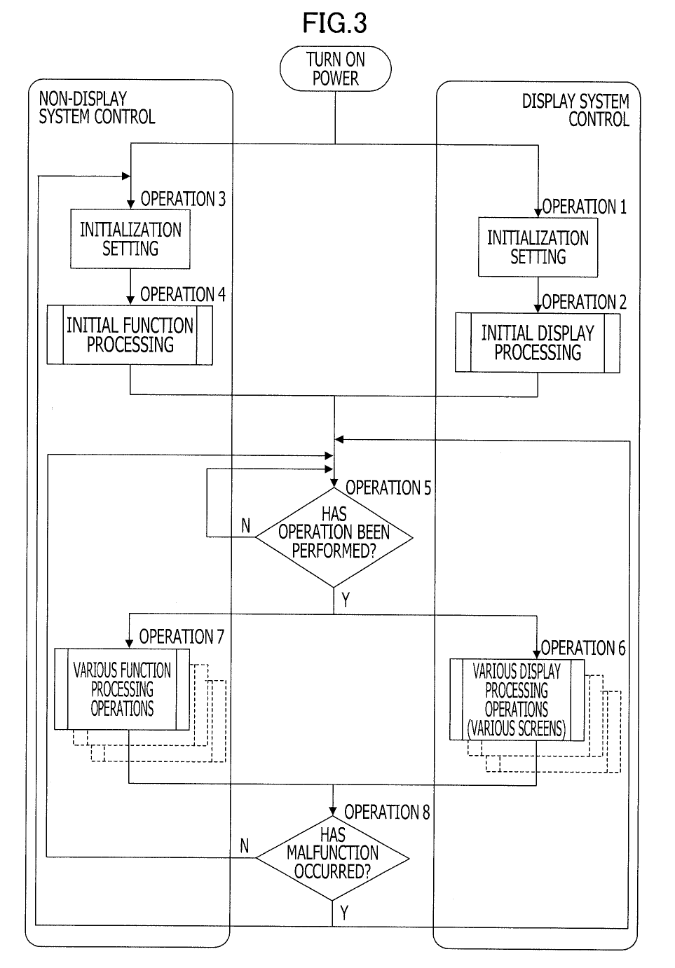

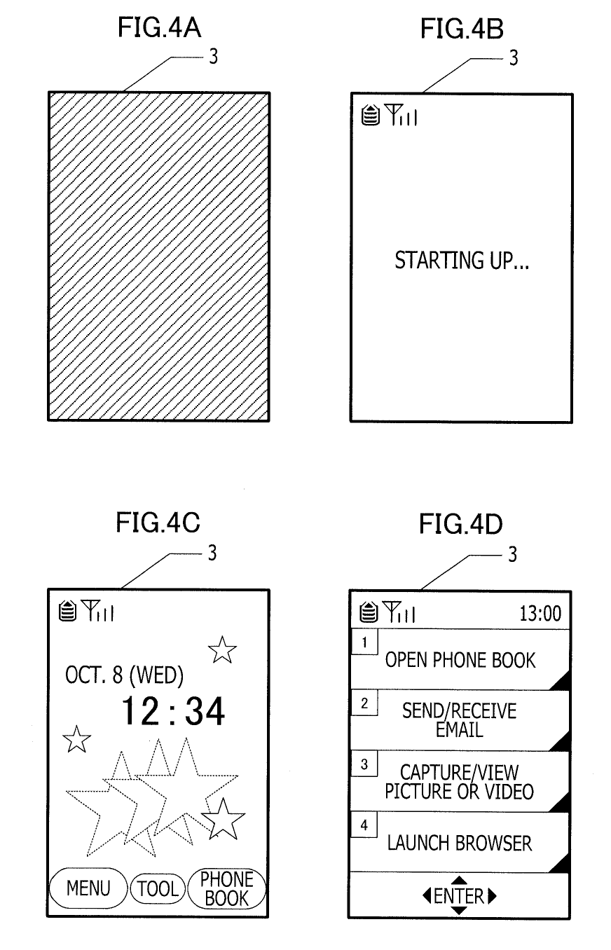

Next, operations (a start-up processing, a steady-state processing, and a restart processing) of the portable telephone 1 according to an embodiment will be described with reference to FIGS. 3, 4A, 4B, 4C and 4D. FIGS. 4A, 4B, 4C and 4D illustrate an example of screen display in start-up processing, steady-state processing, and restart processing of the portable telephone 1.

First, a start-up processing performed when power is turned on will be described. When a power key of the keypad 4 is pressed in the power-OFF state, a power-ON signal is input via the operation unit 16 and the central processing unit 11 and power supply 13 are energized. Upon receiving the power-ON signal, the central processing unit 11 commands the power supply 13 to perform power-ON processing. Upon receiving a command from the central processing unit 11, the power supply 13 executes power-ON processing and applies the power-supply voltage to the display unit 14 and the function units 15 to 19. When the power is turned on, an internal reset signal is automatically and continuously applied to the various units of the circuits of the portable telephone 1. Then, after a predetermined time has passed, applying of the internal reset signal is stopped and the various units of the circuits are shifted to being in a state in which the various units of the circuits can be controlled. Here, display on the panel 3 is in a black-image state (FIG. 4A).

Next, the central processing unit 11 executes start-up processing for starting up display control and non-display control systems. As start-up processing for starting up the display control system, the central processing unit 11 commands the display unit 14 to perform the initialization setting (OPERATION 1). More specifically, the central processing unit 11 reads initial setting parameters for the display unit 14 from the memory 12, notifies the display unit 14 of these initial setting parameters, and commands the display unit 14 to set these initial setting parameters. Here, display on the panel 3 is in the black-image state (FIG. 4A).

Furthermore, the central processing unit 11 commands the display unit 14 to perform an initial operation (initial display processing) (OPERATION 2). More specifically, as initial display processing, the central processing unit 11 first reads a start-up screen from the memory 12 and commands the display unit 14 to perform processing for displaying this start-up screen. The start-up screen is stored in the frame memory 22, and the panel 3 continues displaying this start-up screen (FIG. 4B). Display of this start-up screen notifies the user that the portable telephone 1 is starting up. Furthermore, when the central processing unit 11 completes start-up processing for starting up the non-display control system (OPERATIONS 3 and 4 described below), the central processing unit 11 reads a standby screen from the memory 12 and commands the display unit 14 to perform processing for displaying this standby screen. Instead of the start-up screen, the standby screen is stored in the frame memory 22 and the panel 3 continues displaying this standby screen (FIG. 4C). As described above, the start-up screen is displayed on the panel 3 until start-up processing is completed. Upon completion of start-up processing, the standby screen is displayed on the panel 3.

In parallel with OPERATIONS 1 and 2, the central processing unit 11 executes start-up processing for starting up the non-display control system. More specifically, the central processing unit 11 reads various initial setting parameters from the memory 12 and commands the function units 15 to 19 to perform the initialization setting by notifying the function units 15 to 19 of the various initial setting parameters (OPERATION 3). Furthermore, the central processing unit 11 commands the function units 15 to 19 to perform an initial operation (initial function processing) (OPERATION 4). As initial function processing, for example, the central processing unit 11 outputs a start-up sound from the speaker 8 via the operation unit 16, and the central processing unit 11 notifies the user that the portable telephone 1 is starting up.

This above description explains start-up processing and the procedure shifts to a steady-state processing. When the procedure shifts to steady-state processing, the panel 3 displays the standby screen (FIG. 4C).

In steady-state processing, the central processing unit 11 determines whether an operation has been performed (OPERATION 5). When, for example, a key switch of the keypad 4 is operated by a user and an operation input signal is input via the operation unit 16, the central processing unit 11 determines that a corresponding operation has been performed. If the central processing unit 11 determines that an operation has not been performed (NO in OPERATION 5), processing in OPERATION 5 is repeatedly performed at predetermined time intervals to wait for an operation to be performed. Here, the panel 3 continues displaying the standby screen (FIG. 4C).

If the central processing unit 11 determines that an operation has been performed (YES in OPERATION 5), the central processing unit 11 specifies one or more function units related to the performed operation from among the function units 14 to 19, reads necessary data from the memory 12, and commands the function unit or units, which are specified from among the function units 14 to 19, to operate.

More specifically, when the performed operation is an operation related to the panel 3, the central processing unit 11 creates a screen, which is to be displayed, by using data read from the memory 12, notifies the display unit 14 of the created screen, and commands the display unit 14 to perform various display processing operations (OPERATION 6). The screen, which has been sent as the notification, is stored instead of the screen already stored in the frame memory 22, in the frame memory 22. The panel 3 continues displaying this newly stored screen. For example, when an operation for selecting a menu is performed, the central processing unit 11 creates a menu screen and sends the menu screen as a notification. The panel 3 displays the menu screen (FIG. 4D).

In addition to this, when the performed operation is an operation related to the function units 15 to 19, the central processing unit 11 notifies the function units 15 to 19 of read data and commands the function units 15 to 19 to operate. Upon reception of the command, the function units 15 to 19 execute various function processing operations (OPERATION 7).

Next, the detection unit 31 monitors internal operations of the portable telephone 1 and determines whether a malfunction or the like has occurred (whether a restart operation to be performed) (OPERATION 8). Here, for example, when the menu screen is displayed in OPERATION 6, the panel 3 continues displaying the menu screen (FIG. 4D).

If the detection unit 31 determines that a restart operation need not be performed (NO in OPERATION 8), the procedure returns to OPERATION 5 and steady-state processing in OPERATIONS 5 to 8 is performed again. In this case, after the procedure proceeds to OPERATION 6 and before the display unit 14 is commanded to perform display processing, the panel 3 maintains displaying the screen that is stored in the frame memory 22 and that was displayed in the last OPERATION 6. When the procedure proceeds to OPERATION 6 and the display unit 14 is notified of a new screen and is commanded to perform display processing, the screen stored in the frame memory 22 is updated and the new screen is displayed.

If the detection unit 31 determines that a restart operation to be performed (YES in OPERATION 8), the procedure shifts to restart processing. That is, the procedure returns to OPERATION 3 and the central processing unit 11 executes restart processing in which start-up processing for starting up the non-display control system in OPERATIONS 3 and 4 is executed. Then, the procedure proceeds to OPERATION 5 and shifts to steady-state processing. Here, the panel 3 maintains displaying the screen that is stored in the frame memory 22 and that was displayed in the last OPERATION 6. For example, when a menu screen is displayed in OPERATION 6 and the detection unit 31 determines that a restart operation to be performed in OPERATION 8, the panel 3 continues displaying the menu screen even in steady-state processing after restart processing has been performed (FIG. 4D). As described above, the display screen is maintained when a restart operation is performed, and thus restart processing can be executed without making the user be aware that a restart operation is being performed. Here, in an embodiment, the panel 3 always maintains displaying the screen stored in the frame memory 22. Thus, when the procedure shifts to restart processing, displaying the screen is maintained without requiring of execution of special processing.

Then, in steady-state processing, steady-state processing operations in OPERATIONS 5 to 8 are repeatedly performed. In this case, after the procedure proceeds to OPERATION 6 and before the display unit 14 is commanded to perform display processing, displaying the screen that is stored in the frame memory 22 and that was displayed in the last OPERATION 6 is maintained (FIG. 4D). Here, if the procedure proceeds to OPERATION 6 and the display unit 14 is notified of a new screen and is commanded to perform display processing, the screen stored in the frame memory 22 is updated and the new screen is displayed.

The above description explains the operation of the portable telephone 1. According to an embodiment, when a restart operation to be performed to deal with a malfunction or the like, the restart operation can be automatically executed without making the user be aware that a restart operation is being performed.

Here, as another embodiment, for example, when no operation is performed for a predetermined time after restart processing has been performed or when no operation is performed for a predetermined time so that the mode of the portable telephone 1 is changed to a power-conservation mode or the like and the power of the panel 3 is turned off, the central processing unit 11 may command the display unit 14 to perform display processing in which the panel 3 is made to display a screen, which is the same as that displayed on the panel 3 (for example, a standby screen) in a case where the procedure is shifted from being in a state in which start-up processing is performed to being in the steady state when the power is turned on. As a result, after restart processing has been performed, the central processing unit 11 can make the same screen be displayed as that displayed when the procedure is shifted to being in the steady state after normal start-up processing is performed, at a timing at which it is estimated that the user will not be made upset or anxious.

Moreover, as another embodiment, restart processing for starting up the non-display control system or restart processing for starting up the non-display control system and the display control system, which is similar to start-up processing performed when the power is turned on, may be selectively executed in accordance with a detection result from the detection unit 31. For example, the detection unit 31 selects restart processing for starting up the non-display control system and the display control system when it is assumed that there is a high probability that a malfunction is caused by the display unit 14 in accordance with a restart history and the like (for example, a restart operation is executed more often than a predetermined frequency or the like).

Moreover, an embodiment uses a portable telephone as an example of an electric apparatus; however, embodiments may also be applied to other portable terminal apparatuses including personal digital assistants (PDAs) and other electric apparatuses.

According to various embodiments of an electric apparatus and a method of controlling display, when a restart operation to be performed for dealing with a malfunction or the like, display of a screen on a panel of a display unit can be controlled in such a manner that a restart operation can automatically be executed without making the user be aware that a restart operation is being performed.

According to an embodiment, a method of controlling display includes determining a restart operation is to be automatically performed and controlling a displayer to maintain displaying of a screen while the restart operation is executed until a command is received indicating completion of the restart operation. According to an embodiment, the restart operation is executed without requiring an input request from a user and is triggered by detection of an occurrence of a malfunction.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiment(s) of the present inventions have been described in detail, it should be understood that the various changes, substitutions, and alterations could be made hereto without departing from the spirit and scope of the invention, the scope of which is defined in the claims and their equivalents.

What is claimed is:

1. An electric apparatus, comprising:
a plurality of function units including a display unit causing a panel of the display unit to display a screen and maintaining the display of the screen, the function units other than the display unit executing functions other than a function related to the panel;
a central processing unit that executes a first processing of commanding the plurality of function units to start up and executes a second processing of commanding the plurality of function units to operate in accordance with an operation being performed; and
a detection unit that detects a state in which a restart operation to be performed during the second processing, and
wherein the central processing unit executes a third processing of commanding the function units other than the display unit to start up in accordance with a detection result of the detection unit, and the display unit maintains the display of the screen on the panel until the display unit receives a command to operate from the central processing unit in the second processing after the third processing has been performed.

2. The electric apparatus according to claim 1, wherein the display unit includes a frame memory for storing information of the screen, and maintains displaying of the screen stored in the frame memory by making the panel repeatedly display the screen.

3. A method of controlling display for an electric apparatus including a plurality of function units including a display unit, and causing a panel of the display unit to display a screen, the method comprising:
displaying a screen on the panel and maintaining the displaying of the screen using the display unit;
executing functions other than a function regarding the panel using the function units other than the display unit;
executing a first processing of commanding the plurality of function units to start up and a second processing of commanding the plurality of function units to operate in accordance with an operation being performed;
detecting a state in which a restart operation to be performed during the second processing; and
executing a third processing for commanding the function units other than the display unit to start up in accordance with a detection result from the detecting and maintaining the display of the screen on the panel until the display unit receives a command to operate in the second processing after the third processing has been performed.

4. A method of controlling display, comprising:
determining a restart operation is to be automatically performed; and
controlling a displayer to maintain displaying of a screen while the restart operation is executed until a command is received indicating completion of the restart operation.

5. The method according to claim 4, wherein the restart operation is executed without requiring an input request from a user.

6. The method according to claim 4, wherein the restart operation is triggered by detection of an occurrence of a malfunction.
